(19) United States
(12) Patent Application Publication
(10) Pub. No.: US 2006/0136218 A1
(43) Pub. Date: Jun. 22, 2006

(54) Method for optimizing loads of speech/user recognition system

(75) Inventor: Yun-wen Lee, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan (TW)

(21) Appl. No.: 11/300,048

(22) Filed: Dec. 14, 2005

(30) Foreign Application Priority Data
Dec. 16, 2004 (TW) 093139222

(51) Int. Cl. G10L 11/00

(52) U.S. Cl. 704/270.1

(57) ABSTRACT

A method for optimizing a load of a speech/user recognition system is provided. The speech/user recognition system comprises a server end, a client end and a network, and the method is achieved by performing N stages of computations for speech features of a speech, where N is a positive integer, and an i is selected from 1 to N for representing the i^{th} stage speech features, comprising steps of: (a) providing a real time factor Ta(i) for computing a respective stage i of the speech features at the client end, where Ta(i) is an average computation time of computing the i^{th} stage speech features at the client end with respect to one second input speech; (b) providing a real time factor Tb(i) for computing a respective stage i of the speech features at the server end, where Tb(i) is an average computation time of computing the i^{th} stage speech features at the server end with respect to one second input speech; (c) providing a load c of the server end and a load d of the network; (d) deciding an n in the range from 1 to N for minimizing a recognition time Tₒᵤₜₚᵤₜ of the speech; (e) inputting the speech with time Tᵢₙₚᵤₜ for being recognized; (f) performing an computation from the first stage speech features to the n^{th} stage speech features of the speech at the client end, while performing an computation from the (n+1)^{th} stage speech features to the N^{th} stage speech features of the speech at the server end; and (g) repeating steps (e) to (f).

### FIELD OF THE INVENTION

The present invention relates to an optimization method, in particular, to an optimization method adopted in the speech/user recognition system.

### BACKGROUND OF THE INVENTION

In this era over which the network prevails (especially, the prosperity of the Internet), massive trade processes and entertainment activities have already been brought to people via the network for providing the daily services for people. However, most of the World Wide Web users are limited with manipulating the input/output device based on the non-voice-commanded equipments such as the mouse, the keyboard, the touch panel, the trackball, the printer, the monitor, etc. merely. Because those equipments are not in compliance with the human nature that humans communicate with each other in voice/speech approach possessing the advantage of fine convenience, the development of the communication between Internet and humans encounters quite a few bottlenecks in practice. Therefore, the scientists/engineers get started to carry out the speech/user recognition system to be the interface adopted in the communications between humans and computer machines, which enables the interactive behavior occurred on the Internet to be more suitable for gratifying the need of humanization.

In recent years, the rapid developments of the speech/user recognition system and the telecommunication render the application of the relevant techniques thereof more widespread, rather than narrowly limited to be used in only a single personal computer. With regard to various types of the speech/user recognition system, the user is allowed to input the speech via different devices at different locations. The inputted speech is transferred to the central processing system, and the corresponding response is responded to the user in an adequate manner (e.g. in the text approach, in the picture approach, or in the voice approach) after the recognition is performed by the central processing system.

Regarding the speech/user recognition technique, the processing of speech feature extraction is considerably critical. The correct recognition results are based on the comparison between the characteristics analyzed from processed feature signal and those set up by the predetermined module, for obtaining the accurate recognition results.

Please refer to FIG. 1, which is a flow chart for recognizing a speech signal by a conventional speech/user recognition system. A speech signal is inputted by a user via a conventional input device (for example, a microphone). The speech signal is processed with the adequate pre-processing steps (for example, amplifying the signal, normalizing, pre-emphasizing, multiplying the Hamming window, passing the low frequency filter or the high frequency filter, etc.). Next, the speech signal is proceeded with the step of the speech feature extraction processing. The feature extraction processing is based on the unit of the frame which the processing is carried out for each frame, e.g. transferring the speech signal into the spectrum via Fast Fourier Transform (FFT) technique, obtaining the Mel-Frequency Cepstrum Coefficients (MFCC), the brightness, the zero crossing rate, and the fundamental frequency analysis from the spectrum. At last, the features are compared with the set up features in the database, and then appropriately returned to the user from the server end.

The speech feature extraction processing of the conventional speech/user recognition system is quite dependent on the capability of the central processing unit connected to the recognition engine, and the transferring time required also depends on the bandwidth. Because the speech/user recognition system was not popular in the past, the overloads of the central processing unit and the network are not frequently happened. However, by the various wide-spreading applications of the system and the massively increased numbers of the users, the loads of the central processing unit and network have became more and more demanding, which makes numerous users in the Queue spend excessive time for waiting for the return of the recognition result. Hence, the requirement of real time response to the user could not be satisfied.

Presently, there are two methods for solving the aforementioned problems. The first method is that the calculation is shared out respectively by the server end and by the client end (e.g. PDA, the set-top box, etc.). Basically, for the first method, the amount of respective loading calculation is predetermined according to the processing capability of the server end and client end. However, the method lacks the function for dynamically adjusting the load, and thus the client is not possible to share more calculation for cutting down the waiting time for the calculation if the load is suddenly increased. Once the amount of input devices is increased, the waiting time at each client end will be correspondingly raised. Thus it is impossible to efficiently solve the problem of the excessive waiting time arisen due to the massive inputs.

The second method is to readjust the efficiency of the feature at each stage when overloading. That means to forsake the accuracy of the feature to acquire faster calculating time. Though the second method is for dynamically adjusting the load and for cutting down the waiting time, the correctness for recognizing the speech/user is degraded.

For overcoming the mentioned drawbacks of the prior art, a novel method for optimizing loads of the speech/user recognition system is provided.

### SUMMARY OF THE INVENTION

According to the aforementioned of the present application, a method for optimizing a load of a speech/user recognition system is provided. The speech/user recognition system includes a server end, a client end and a network, and the method is achieved by performing N stages of computations for a speech feature of a speech, where N is a positive integer, and an i is selected from 1 to N for representing the i^{th} stage speech feature, including steps of: (a) providing a real time factor Ta(i) for respective stage i of the speech feature at the client end, where Ta(i) is for an average computation time of computing the i^{th} stage speech feature at the client end with respect to one second input speech; (b) providing a real time factor Tb(i) for respective stage i of the speech feature at the server end, where Tb(i) is for an average computation time of computing the i^{th} stage speech feature at the server end with respect to one second input speech; (c) providing a load c of the server end and a load d of the network; (d) deciding an n in the range from 1 to N for minimizing a recognition time Tᵢₙₚᵤₜ of the speech; (e) inputting the speech for being recognized within a time Tᵢₙₚᵤₜ; (f) performing an computation from the first stage speech feature to the n^{th} stage speech feature of the speech at the client end, while performing an computation from the (n+1)^{th} stage speech feature to the N^{th} stage speech feature of the speech at the server end; and (g) repeating steps (e) to (f).

Preferably, the step (c) further including steps of: (c1) inputting a first speech for being recognized with a first input time Tᵢₙₚᵤₜ₁, wherein an accomplishment of the first speech recognition takes a first output time Tₒᵤₜₚᵤₜ₁; and (c2) inputting a second speech for being recognized within a second input time Tᵢₙₚᵤₜ₂, wherein an accomplishment of the second speech recognition takes a second output time Tₒᵤₜₚᵤₜ₂.

Preferably, the data size of first speech feature of stage n is Dn(Tᵢₙₚᵤₜ₁)

Preferably, a time for the first speech feature of stage n being transferred via the network is Dn(Tᵢₙₚᵤₜ₁)/d.

Preferably, the data size of second speech feature of stage n is Dn(Tᵢₙₚᵤₜ₂).

Preferably, a time for the second speech feature of stage n being transferred via the network is Dn(Tᵢₙₚᵤₜ₂)/d.

Preferably, the data size of speech feature of stage n is Dn(Tᵢₙₚᵤₜ₂).

Preferably, a time for the speech feature of stage n being transferred via the network is Dn(Tᵢₙₚᵤₜ)/d.

Preferably, a transmitting time for a recognition result via the network is K/d.

Preferably, the step (c1) further including steps of: (c11) providing an n₁ in the range from 1 to N; and (c12) performing an computation for the first stage speech feature to the n₁^{th} stage speech feature of the first speech at the client end, while performing an computation from the (n₁+1)^{th} stage speech feature to the N^{th} stage speech feature of the first speech at the server end.

Preferably, a computation time for the computation from the first stage speech feature to the n₁^{th} stage speech feature of the first speech at the client end is

$${T}_{input 1} ⨯ {\sum }_{i = 1}^{{n}_{1}} Ta ( i ) .$$

Preferably, a computation time for an computation from the (n₁+1)^{th} stage speech feature to the N^{th} stage speech feature of the first speech at the server end is

$${T}_{input 1} ⨯ \frac{1}{c} {\sum }_{i = {n}_{1} + 1}^{N} Tb ( i ) .$$

Preferably, a computation time for computing total N stages of the speech feature of the first speech is

$${T}_{input1} ⨯ ( {\sum }_{i = 1}^{{n}_{1}} Ta ( i ) + \frac{1}{c} {\sum }_{i = {n}_{1} + 1}^{N} Tb ( i ) ) .$$

Preferably, the first output time is a summation of the computation time for computing total N stages of the speech feature of the first speech, the time for transferring the first speech feature via the network, and the time for returning a recognition result via the network, and equals to

$${T}_{output 1} = {T}_{input 1} ⨯ ( {\sum }_{i = 1}^{{n}_{1}} Ta ( i ) + \frac{1}{c} {\sum }_{i = {n}_{1} + 1}^{N} Tb ( i ) ) + \frac{1}{d} Dn ( {T}_{input 1} ) + \frac{1}{d} K .$$

Preferably, the step (c2) further including steps of: (c21) providing an n₂ in the range from 1 to N; and (c22) performing an computation from the first stage speech feature to the n₂^{th} stage speech feature of the second speech at the client end, while performing an computation from the (n₂+1)^{th} stage speech feature to the N^{th} stage speech feature of the first speech at the server end.

Preferably, a computation time for the computation from the first stage speech feature to the n₂^{th} stage speech feature of the second speech at the client end is

$${T}_{input 2} ⨯ {\sum }_{i = 1}^{{n}_{2}} Ta ( i ) .$$

Preferably, a computation time for an computation from the (n₂+1)^{th} stage speech feature to the N^{th} stage speech feature of the second speech at the server end is

$${T}_{input 2} ⨯ \frac{1}{c} {\sum }_{i = {n}_{2} + 1}^{N} Tb ( i ) .$$

Preferably, a computation time for computing total N stages speech feature of the second speech is

$${T}_{input 2} ⨯ ( {\sum }_{i = 1}^{{n}_{2}} Ta ( i ) + \frac{1}{c} {\sum }_{i = {n}_{2} + 1}^{N} Tb ( i ) ) .$$

Preferably, the second output time is a summation of the computation time for computing total N stages of the speech feature of the second speech, the time for transferring the second speech feature via the network, and the time for returning a recognition result via the network, and equals to

$${T}_{output 2} = {T}_{input 2} ⨯ ( {\sum }_{i = 1}^{{n}_{2}} Ta ( i ) + \frac{1}{c} {\sum }_{i = {n}_{2} + 1}^{N} Tb ( i ) ) + \frac{1}{d} Dn ( {T}_{input 2} ) + \frac{1}{d} K$$

Preferably, the computation time for being recognized the speech is the summation of computation time for computing total N stages speech features for the speech, the time for transferring the speech feature via the network, and the time for returning a recognition result via the network, and equals to

$${T}_{output} = {T}_{input} ⨯ ( {\sum }_{i = 1}^{n} Ta ( i ) + \frac{1}{c} {\sum }_{i = n + 1}^{N} Tb ( i ) ) + \frac{1}{d} Dn ( {T}_{input} ) + \frac{1}{d} K$$

According to the aforementioned of the present application, a method for optimizing a recording frame-synchronized speech feature computation comprising a server end, a client end and a network, and the method is achieved by performing N stages of computations for a speech feature of a speech having N′ frames, where N and N′ are a positive integers, where an i is selected from the range from 1 to N for representing the i^{th} stage speech feature, and a n′ is selected from the range from 1 to N′ for representing the n^{th} frame, comprising steps of: (a) providing an specific n in the range from 1 to N; (b) inputting said speech for an input time (Tᵢₙₚᵤₜ), wherein an computation for the first stage speech feature to the n^{th} stage speech feature of the each frame of the speech is performed at the client end, and an computation from the (n+1)^{th} stage speech feature to the N^{th} stage speech feature of the each frame of the speech is performed at the server end; (c) after the step (b) is carried out, an computation of the n′ frames is achieved, and a speech feature computation of the n^{th} stage of the (n′+1)^{th} frame is achieved, modifying the n by a specific manner according to the n₁ to minimize a computation time for recognizing the speech; and (d) performing an computation from the first stage speech feature to the n^{th} stage speech feature of the respective remaining frames at the client end according to the modified n in step (c), while performing an computation for the (n+1)^{th} stage speech feature to the N^{th} stage speech feature of the respective remaining frames at the server end.

Preferably, the method is used in a recording frame-synchronized speech feature computation system.

Preferably, in the step (b) the recording frame-synchronized speech feature computation system that speech feature extraction synchronously with speech recording.

Preferably, in the step (c) an computation of the n′ frames is achieved by the recording frame-synchronized speech feature computation system.

Preferably, n in the step (a) is obtained according to the method as recited in claim 1.

Preferably, a factor Ta(i) is for an average computation time of computing the i^{th} stage speech feature at the client end with respect to the input speech.

Preferably, a factor Tb(i) is for an average computation time of computing the i^{th} stage speech feature at the server end with respect to the input speech.

Preferably, a computation time for an operation from the first stage speech feature to the n^{th} stage speech feature of the speech at the client end is

$${T}_{input} ⨯ {\sum }_{i = 1}^{n} Ta ( i ) .$$

Preferably, a computation time for an computation from the (n+1)^{th} stage speech feature to the N^{th} stage speech feature of said speech at the server end is

$${T}_{input} \times \frac{1}{c} {\sum }_{i = n + 1}^{N} Tb ( i ) .$$

Preferably, a computation time for computing total N stages of the speech feature of the speech is

$${T}_{input} \times ( {\sum }_{i = 1}^{n} Ta ( i ) + \frac{1}{c} {\sum }_{i = n + 1}^{N} Tb ( i ) ) .$$

Preferably, the data size of speech feature of stage n is Dn(Tᵢₙₚᵤₜ).

Preferably, a time for the speech feature of stage n being transferred via the network is Dn(Tᵢₙₚᵤₜ)/d.

Preferably, a transmitting time for a recognition result being returned by the network is K/d.

Preferably, the specific manner in the step (c) uses: (c1) if n₁ is smaller than n, an equation

$$\begin{matrix}n = {Arg}_{n} ( Min ( {T}_{input} \times [ ( {\sum }_{i = 1}^{n} Ta ( i ) + \frac{1}{c} {\sum }_{i = n + 1}^{N} Tb ( i ) ) + \\ {\sum }_{i = {n}_{1}}^{n} Ta ( i ) + \frac{1}{c} {\sum }_{i = n + 1}^{N} Tb ( i ) ] + \frac{1}{d} Dn ( {T}_{input} ) + \frac{1}{d} K ) )\end{matrix}$$

is used for obtaining the modified n; and (c2) if n₁ is greater than n, an equation

$$\begin{matrix}n = {Arg}_{n} ( Min ( {T}_{input} \times [ ( {\sum }_{i = 1}^{n} Ta ( i ) + \frac{1}{c} {\sum }_{i = n + 1}^{N} Tb ( i ) ) + \\ \frac{1}{c} {\sum }_{i = {n}_{1} + 1}^{N} Tb ( i ) ] + \frac{1}{d} Dn ( {T}_{input} ) + \frac{1}{d} K ) )\end{matrix}$$

is used for obtaining the modified n, wherein c is a load of the server end and d is a load of the network.

Preferably, the c the d are obtained according to the method as recited in claim 1.

According to the aforementioned of the present application, a method for optimizing a load of a speech/user recognition system including a server end, a client end and a network, wherein a recognition is achieved by performing plural stages of computations to a speech feature of a speech having an inputting time, including steps of: (a) providing a real time factor Ta(i) for a respective stage i speech feature computing at the client end; (b) providing a real time factor for a respective stage i speech feature at the server end; (c) providing a load of the server end and a load of the network; (d) obtaining a specific amount according to the load of the server end and the load of the network to minimize a computation time for recognizing the speech; and (e) determining the computation at the client end and the server end according to the specific amount and performing the plural stages of computations for the speech features of the speech.

Preferably, the step (c) further including steps of: (c1) inputting a first speech to be recognized during a first input time, where an accomplishment of a recognition of the first speech is a first output time; and (c2) inputting a second speech to be recognized during a second input time, where an accomplishment of a recognition of the second speech is a second output time; and (c3) estimating the load of the server end and the load of the network according to the first and second output times of (c1) and (c2).

Preferably, the computation time for computing all stages of the speech feature at the client end is directly proportional to the inputting time.

Preferably, the computation time for computing all stages of the speech feature at the server end is directly proportional to the inputting time.

Preferably, the speech includes a data size.

Preferably, a time for transferring the speech feature via network is a ratio of the data size to the load of the network.

Preferably, a time for computing all the speech features is a summation of the respective times of time for computing the speech feature at the client end and at the server end.

Preferably, an output time of the speech is a summation of the computation time for computing all the speech features, the time for transmitting the speech feature via the network, and the time for transmitting a recognition result via the network.

According to the aforementioned of the present application, a method for optimizing a recording frame-synchronized speech feature computation comprising a server end, a client end and a network, wherein a recognition of a speech is achieved by performing plural stages of computations for a speech feature of the speech having plural frames, including steps of: (a) providing a specific amount; (b) inputting the speech for an input time; (c) after the step (b) is carried out when a part of the plural frames has not been computed, and only part computations of the plural stages for the speech feature of a first frame of the frames having not been computed, modifying the specific amount by a specific manner, to minimize a computation time for recognizing the speech; and (d) distributing the respective loads of the server end and the client end according to the modified specific amount in the step (c) and then performing computations for the frames having not been computed to achieve the recognition.

Preferably, the method is used in a recording frame-synchronized speech feature computation system.

Preferably, the recording frame-synchronized speech feature computation system synchronously performs the speech feature computations, wherein the system distributes the respective computation at the client end and the server end according to the specific amount

Preferably, the specific amount in the step (a) is obtained according to the method as recited in claim 1.

Preferably, a computation time for computing one of the plural stages of computations at the client end is directly proportional to the input time.

Preferably, a computation time for computing one of the plural stages of computations at the server end is directly proportional to the input time.

Preferably, the speech includes a data size.

Preferably, a time for transmitting the speech feature via the network is the ratio of the data size to the load of the network.

Preferably, a time for all plural stages of computations is the summation of a time for computing the speech feature at the client end and a time for computing the speech feature at the server end.

Preferably, an output time of the speech recognition is the summation of a time for computing the speech feature, a time for transmitting the speech features via the network, and a time for transmitting a recognition result via the network.

### BRIEF DESCRIPTION OF THE DRAWINGS

FIG. 1 is a flow chart for recognizing a speech signal by a conventional speech/user recognition system;

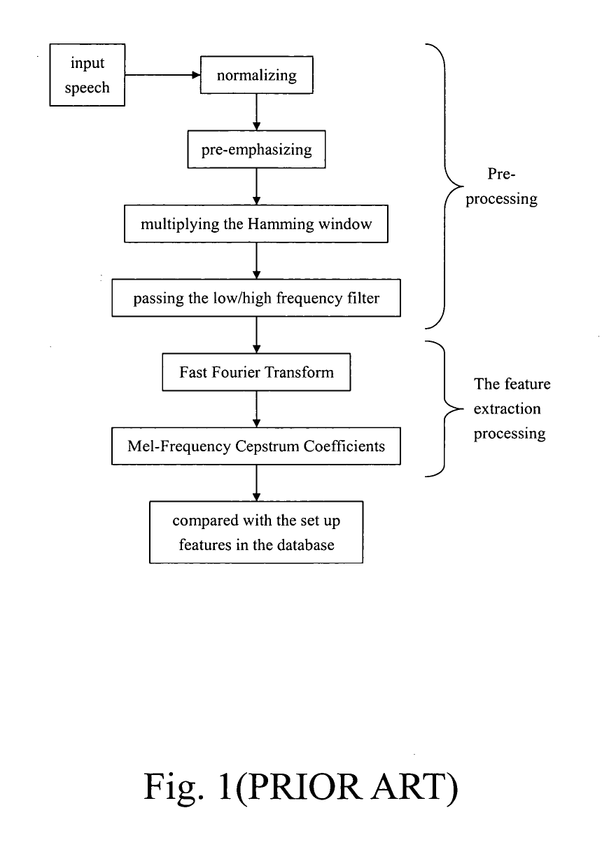

FIG. 2 is a flow chart for one of the preferred embodiments of the method for optimizing the load of the speech/user recognition system according to the present invention.

FIG. 3 is a flow chart for one of the preferred embodiments of the method for optimizing the time for recording frame-synchronized speech feature computation according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspect of illustration and description only; it is not intended to be exhaustive or to be limited to the precise form disclosed.

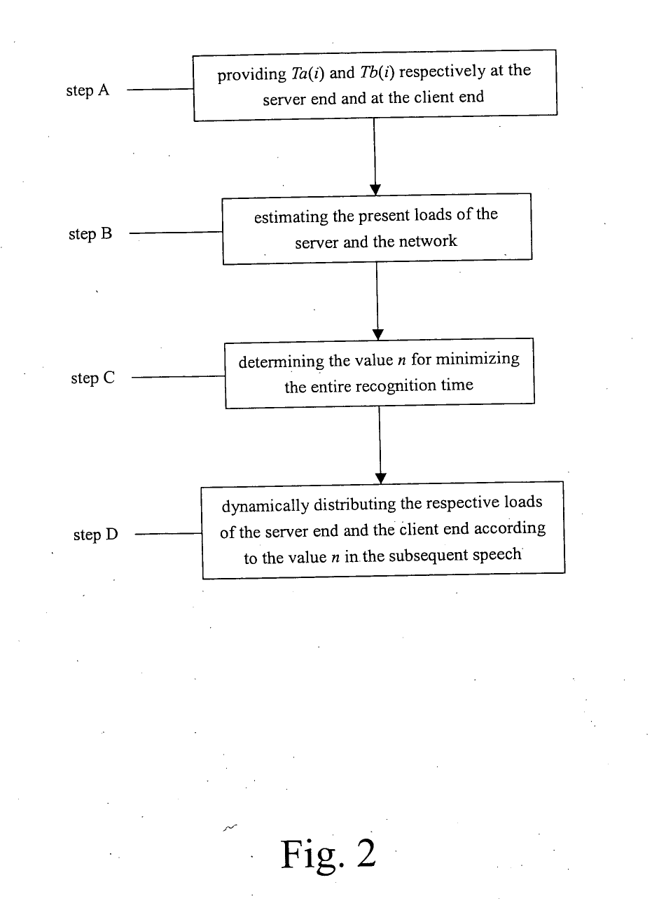

Please refer to FIG. 2, which is a flow chart for one of the preferred embodiments of the method for optimizing the load of the speech/user recognition system according to the present invention. To begin in the beginning, because the information about the central processing unit configured to the server end and the client end is publicly known in advance, the computation time for the recognition engine to process the feature at each stage respectively at the server end and at the client end is provided in step A. The computation time must be a factor of the real time with respect to the input time. Therefore when the speech features of stage i^{th} are proceeded at the client end, the computation time is the factor of real time factor Ta(i) that is the client, in average, takes Ta(i) seconds to compute one second speech for i^{th} stage. If the client end is the hardware such as a PDA, etc. prepared by the user, the Ta(i) is obtained according to the average of the several previous practical computation times. If the client end is the hardware such as a set-top box, etc. provided by the manufacturer, the Ta(i) is obtained according to the average estimation of the several practical computation times pre-executed by the manufacturer. In the same manner, when the speech features of stage i^{th} proceeded at the server end, the computation time is also known as the factor of real time factor Tb(i). The server end is usually the hardware provided by the system supplier, and therefore the Tb(i) is obtained according to the average estimation of the several practical computation times pre-executed by the system supplier. If the server end is not the hardware provided by the system supplier, the Tb(i) is obtained according to the average of the several previous practical computation times. Consequently, the present loads of the server and the network are estimated in step B. In step C, according to the information obtained in step A and step B, i.e. the Ta(i), the Tb(i), the present server load and the present network load, the value n is determined for minimizing the entire recognition time. At last, in step D, the respective loads of the server end and the client end are distributed according to the value n in the subsequent speech recognition process, until the aforementioned value n is refreshed again. Hence it is achieved the aspect for presenting the function of the shortest waiting time at the client end.

In practical performance, the current loads of the server and the network in step B are obtained via the following procedures. In the beginning, a first speech is inputted for performing the recognition, and a computation time Tᵢₙₚᵤₜ₁ for inputting the first speech and an output time Tₒᵤₜₚᵤₜ₁ for accomplishing the recognition of the first speech and bounding the recognition result are measured. Next, a second speech is inputted for performing the recognition, and a computation time Tᵢₙₚᵤₜ₂ for inputting the second speech and an output time Tₒᵤₜₚᵤₜ₂ for accomplishing the recognition of the second speech and bounding the recognition result are measured. Then the mentioned measured input times (Tᵢₙₚᵤₜ₁, Tᵢₙₚᵤₜ₂) and the output times (Tₒᵤₜₚᵤₜ₁, Tₒᵤₜₚᵤₜ₂) are substituted into the following Equation (1) for forming the joint equations to respectively acquire the present load of the server c and the load of the network d:

$$Equation ( 1 ) : \\ {T}_{output} = {T}_{input} \times ( {\sum }_{i = 1}^{n} Ta ( i ) + \frac{1}{c} {\sum }_{i = n + 1}^{N} Tb ( i ) ) + \frac{1}{d} Dn ( {T}_{input} ) + \frac{1}{d} K ,$$

wherein N represents the total N stages speech feature computation, c represents the present load of the server, d represents the present load of the network;

$${T}_{input} \times {\sum }_{i = 1}^{n} Ta ( i )$$

represents the computation time from the first stage to the N^{th} stage;

$${T}_{input 1} \times \frac{1}{c} {\sum }_{i = n + 1}^{N} Tb ( i )$$

represents the computation time for computing the speech feature from the (n+1)^{th} stage to the N^{th} stage; Dn(Tᵢₙₚᵤₜ) represents the data size of the speech; Dn(Tᵢₙₚᵤₜ)/d represents the transmitting time for transmitting a speech feature via the network having a load d; K represents the size of the result returned; K/d represents the returning time for returning speech recognition result via the network having a load d, which is regarded as a constant because the variation of the size for the recognition result thereof is usually slight; Tₒᵤₜₚᵤₜ represents the output time for accomplishing a recognition which is a summation of the computation time for computing the speech feature at the client end, a computation time for computing the speech feature at the server end, the transmitting time for a transmitting a speech feature via the network, and the returning time for returning a speech recognition result via the network. Besides, in the step C, the value n for minimizing the outputting time is obtained according to the following Equation (2):

$$Equation ( 2 ) : \\ n = {Arg}_{n} ( Min ( {T}_{input} \times ( {\sum }_{i = 1}^{n} Ta ( i ) + \frac{1}{c} {\sum }_{i = n + 1}^{N} Tb ( i ) ) + \frac{1}{d} Dn ( {T}_{input} ) + \frac{1}{d} K ) ) ,$$

The present application re-operates the loads of the server end and the network end for a fixed time depending on the practical situation for estimating a new value n so as to optimize the next entire recognition time. Furthermore, if the variation of the load of server end is slight, the load of the server end is obtained upon the previous response. Thus and then the server end broadcasts the estimated load for next time per fixed time, and the load of the network is estimated per practical estimating time, and the value n needed for next time is estimated accordingly. Besides, before enough relevant information is collected, a value n is estimated based on the experience, till enough relevant information is collected for estimating the loads of the network and the server end.

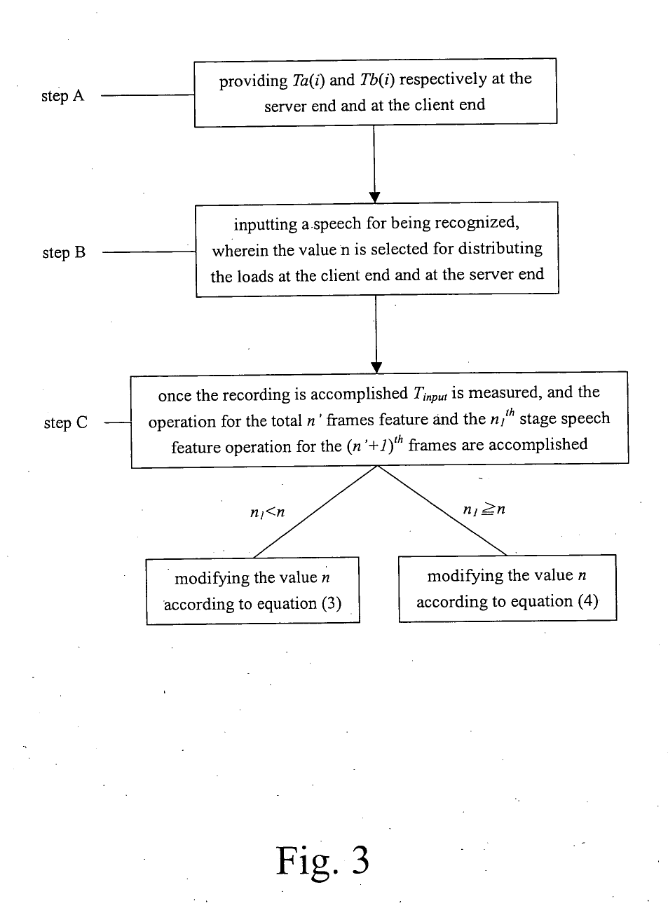

Please refer to FIG. 3, which is a flow chart for one of the preferred embodiments of the method for optimizing the recording frame-synchronized speech feature computation according to the present application. Because the recording frame-synchronized speech recognition system is synchronously performed while the voice is recorded, once the recording starts, the feature computation is sequentially performed by the recognition engine for each frame constituting the speech at the beginning of the recoding, rather than at the end of the recording. Initially, because the information about the central processing unit configured respectively to the client end and the server end is known in advance, the computation time for each stage speech feature extraction respectively at the client end and at the server end are pre-provided in step A, wherein the computation time must present a factor of factor-like relationship with respect to the real time factor of the input time. Thus the computing time is obtained as the factor of real time factor Ta(i), while computing the speech features of stage i^{th}. If the client end is the hardware prepared by the users themselves such as a PDA, etc., the Ta(i) is obtained according to the average of the several previous practical computation times. If the client end is the hardware provided by the manufacturer such as a set-top box, etc., the Ta(i) is obtained according to the average estimation of the several practical computation times pre-executed by the manufacturer. In the same way, when the speech features of stage i^{th} is computed at the server end, the computation time is also known as the factor of real time factor Tb(i). The server end is usually the hardware provided by the system supplier, and therefore the Tb(i) is obtained according to the average estimation of the several practical computation times pre-executed by the system supplier. If the server end is not the hardware provided by the system supplier, the Tb(i) is obtained according to the average of the several previous practical computation times. Consequently, in the step B, a speech with length Tᵢₙₚᵤₜ, is inputted for being recognized. Since the total time (Tᵢₙₚᵤₜ) for input speech is unknown before the end of the recording, the value n is selected for distributing the load for computing the speech feature respectively at the client end and the server end according to the method as described in the aforementioned or the computation experience, before the end of the recording. In step C, once the recording is accomplished, the time (Tᵢₙₚᵤₜ) is measured. It is assumed that in the time the computation for the total n′ frames features are accomplished by the recording frame-synchronized speech feature computation system and the n₁^{th} stage speech feature computation for the (n′+1)^{th} frames is accomplished, and in the mean time, if the value n₁ is smaller than the value n provided in the step B, the value n is modified according to the following equation (3) for minimizing the entire recognition time (Tₒᵤₜₚᵤₜ):

$$Equation ( 3 ) : \\ n = {Arg}_{n} ( Min ( {T}_{input} \times [ ( {\sum }_{i = 1}^{n} Ta ( i ) + \frac{1}{c} {\sum }_{i = n + 1}^{N} Tb ( i ) ) + {\sum }_{i = {n}_{1}}^{N} Ta ( i ) + \frac{1}{c} {\sum }_{i = n + 1}^{N} Tb ( i ) ] + \frac{1}{d} Dn ( {T}_{input} ) + \frac{1}{d} K ) ) ,$$

wherein N represents the total N stages speech feature computation, c represents the present load of the server, d represents the present load of the network;

$${T}_{input} \times ( {\sum }_{i = 1}^{n} Ta ( i ) + \frac{1}{c} {\sum }_{i = n + 1}^{N} Tb ( i ) )$$

represents the distributing time for distributing the remaining computations of the speech feature distributed respectively to the client end and to the server end according to the modified value n;

$${T}_{input} \times ( {\sum }_{i = {n}_{1}}^{n} Ta ( i ) + \frac{1}{c} {\sum }_{i = n + 1}^{N} Tb ( i ) )$$

represents the distributing time for distributing the remaining computations of the (n′+1)^{th} speech feature distributed respectively to the client end and to the server end according to the modified value n; Dn(Tᵢₙₚᵤₜ) represents the data size of the speech feature in stage n; Dn(Tᵢₙₚᵤₜ)/d represents the transmitting time for transmitting a speech feature via the network having a load d; K represents the size of the recognition result returned; K/d represents the returning time for returning the recognition result via the network having a load d, which could be regarded as a constant because the variation of the size for the recognition result thereof is usually slight. In the step C, if the value n, is greater than or equal to the value n provided in the step B, the value n is modified according to the following equation (4) for minimizing the entire recognition time (Tₒᵤₜₚᵤₜ):

$$Equation ( 4 ) \text{:}$$

$$n = {Arg}_{n} ( Min ( {T}_{input} \times [ ( {\sum }_{i = 1}^{n} Ta ( i ) + \frac{1}{c} {\sum }_{i = n + 1}^{N} Tb ( i ) ) + \frac{1}{c} {\sum }_{i = {n}_{1} + 1}^{N} Tb ( i ) ] + \frac{1}{d} Dn ( {T}_{input} ) + \frac{1}{d} K ) ) ,$$

wherein N represents the total N stages speech feature computation, c represents the present load of the server, d represents the present load of the network;

$${T}_{input} \times ( {\sum }_{i = 1}^{n} Ta ( i ) + \frac{1}{c} {\sum }_{i = n + 1}^{N} Tb ( i ) )$$

represents the distributing time for distributing the remaining computations of the speech feature distributed respectively to the client end and to the server end according to the modified value n;

$${T}_{input} \times ( \frac{1}{c} {\sum }_{i = n + 1}^{N} Tb ( i ) )$$

represents the computing time for computing the remaining computations of the (n′+1)^{th} speech feature, and in particular, the computation is completely accomplished at the server end; Dn(Tᵢₙₚᵤₜ) represents the data size of the speech feature of stage n; Dn(Tᵢₙₚᵤₜ)^{th} represents the transmitting time for transmitting speech features of stage n via the network having a load d; K represents the size of the result returned; K/d represents the returning time for returning the recognition result via the network having a load d, recognition result could be regarded as a constant because the variation of the size for the recognition result thereof is usually slight.

To comprehensively sum up the aforementioned, the present invention substantially provides a method for dynamically optimizing the load of the speech/user recognition system with the novelty, the inventiveness, and the utility. The load of the client end is to be dynamically adjusted via estimating the loads of the server end and the network for sharing the work at the server end, which enables the waiting time at each client end and the entire recognition time to be shortest.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

1. A method for optimizing a load of a speech/user recognition system, wherein said speech/user recognition system comprises a server end, a client end and a network, and the method is achieved by performing N stages of computations for a speech feature of a speech, where N is a positive integer, and an i is selected from 1 to N for representing the i^{th} stage speech feature, comprising steps of:
(a) providing a computation time for computing a respective stage i of the speech feature at the client end, wherein a factor Ta(i) is for a computation time of computing the i^{th} stage speech feature at the client end with respect to the input time;
(b) providing a computation time for computing a respective stage i of the speech feature at the server end, wherein a factor Tb(i) is for a computation time of computing the i^{th} stage speech feature at the server end with respect to the input time;
(c) providing a load c of the server end and a load d of the network;
(d) deciding an n in the range from 1 to N for minimizing a recognition time Tₒᵤₜₚᵤₜ of the speech;
(e) inputting the speech for being recognized with a time Tᵢₙₚᵤₜ;
(f) performing an computation from the first stage speech feature to the n^{th} stage speech of the speech at the client end, while performing an computation from the (n+1)^{th} stage speech feature to the N^{th} stage speech feature of the speech at the server end; and
(g) repeating steps (e) to (f).

2. The method according to claim 1, wherein the step (c) further comprising steps of:
(c1) inputting a first speech for being recognized within a first input time Tᵢₙₚᵤₜ₁, wherein an accomplishment of the first speech recognition takes a first output time Tₒᵤₜₚᵤₜ₁; and
(c2) inputting a second speech for being recognized within a second input time Tᵢₙₚᵤₜ₂, wherein an accomplishment of the second speech recognition takes a second output time Tₒᵤₜₚᵤₜ₂.

3. The method according to claim 2, wherein the first speech includes a data size Dn(Tᵢₙₚᵤₜ₁).

4. The method according to claim 3, wherein a time for the first speech features of stage n being transferred via the network is Dn(Tᵢₙₚᵤₜ₁)/d.

5. The method according to claim 4, wherein the data size of second speech features of stage n is Dn(Tᵢₙₚᵤₜ₂).

6. The method according to claim 5, wherein a time for the second speech features of stage n being transferred via the network is Dn(Tᵢₙₚᵤₜ₂)/d.

7. The method according to claim 6, wherein the data size of speech features of stage n includes a data size Dn(Tᵢₙₚᵤₜ).

8. The method according to claim 7, wherein a time for the speech features of stage n being transferred via the network is Dn(Tᵢₙₚᵤₜ)/d.

9. The method according to claim 8, wherein a transmitting time for a recognition result via the network is time K/d.

10. The method according to claim 9, wherein the step (c1) further comprising steps of:
(c11) providing an n₁ in the range from 1 to N; and
(c12) performing a computation from the first stage speech feature to the n₁^{th} stage speech feature of the first speech at the client end, while performing an computation from the (n₁+1)^{th} stage speech feature to the N^{th} stage speech feature of the first speech at the server end.

11. The method according to claim 10, wherein a computation time for the computation from the first stage speech feature to the n₁^{th} stage speech feature of the first speech at the client end is
$${T}_{input 1} \times {\sum }_{i = 1}^{{n}_{1}} Ta ( i ) .$$

12. The method according to claim 11, wherein a computation time for an computation from the (n₁+1)^{th} stage speech feature to the N^{th} stage speech feature of the first speech at the server end is
$${T}_{input 1} \times \frac{1}{c} {\sum }_{i = {n}_{1} + 1}^{N} Tb ( i ) .$$

13. The method according to claim 12, wherein a computation time for computing total N stages of the speech feature of the first speech is
$${T}_{input 1} \times ( {\sum }_{i = 1}^{{n}_{1}} Ta ( i ) + \frac{1}{c} {\sum }_{i = {n}_{1} + 1}^{N} Tb ( i ) ) .$$

14. The method according to claim 13, wherein the first output time is a summation of the computation time for computing total N stages of the speech feature of the first speech, the time for transferring the first speech feature via the network, and the time for returning a recognition result via the network, and equals to
$${T}_{output 1} = {T}_{input 1} \times ( {\sum }_{i = 1}^{{n}_{1}} Ta ( i ) + \frac{1}{c} {\sum }_{i = {n}_{1} + 1}^{N} Tb ( i ) ) + \frac{1}{d} Dn ( {T}_{input 1} ) + \frac{1}{d} K .$$

15. The method according to claim 9, wherein the step (c2) further comprising steps of:
(c21) providing an n₂ in the range from 1 to N; and
(c22) performing an computation from the first stage speech feature to the n₂^{th} stage speech feature of the second speech at the client end, while performing an computation from the (n₂+1)^{th} stage speech feature to the N^{th} stage speech feature of the first speech at the server end.

16. The method according to claim 15, wherein a computation time for the computation from the first stage speech feature to the n₂^{th} stage speech feature of the second speech at the client end is
$${T}_{input 2} \times {\sum }_{i = 1}^{{n}_{2}} Ta ( i ) .$$

17. The method according to claim 16, wherein a computation time for an computation from the (n₂+1)^{th} stage speech feature to the N^{th} stage speech feature of the second speech at the server end is
$${T}_{input 2} \times \frac{1}{c} {\sum }_{i = {n}_{2} + 1}^{N} Tb ( i ) .$$

18. The method according to claim 17, wherein a computation computation time for computing total N stages speech feature of the second speech is
$${T}_{input 2} \times ( {\sum }_{i = 1}^{{n}_{2}} Ta ( i ) + \frac{1}{c} {\sum }_{i = {n}_{2} + 1}^{N} Tb ( i ) ) .$$

19. The method according to claim 18, wherein the second output time is a summation of the computation time for computing total N stages of the speech feature of the second speech, the time for transferring the second speech feature of stage n via the network, and the time for returning a recognition result via the network, and equals to
$${T}_{output 2} = {T}_{input 2} \times ( {\sum }_{i = 1}^{{n}_{2}} Ta ( i ) + \frac{1}{c} {\sum }_{i = {n}_{2} + 1}^{N} Tb ( i ) ) + \frac{1}{d} Dn ( {T}_{input 2} ) + \frac{1}{d} K .$$

20. The method according to claim 1, wherein the computation time for being recognized the speech is the computation time for computing total N stages speech features for the speech, the time for transferring the speech feature of stage n via the network, and the time for returning a recognition result via the network, and equals to.
$${T}_{output } = {T}_{input } \times ( {\sum }_{i = 1}^{n} Ta ( i ) + \frac{1}{c} {\sum }_{i = n + 1}^{N} Tb ( i ) ) + \frac{1}{d} Dn ( {T}_{input } ) + \frac{1}{d} K$$

21. A method for optimizing a recording frame-synchronized speech feature computation comprising a server end, a client end and a network, and the method is achieved by performing N stages of computations for a speech feature of a speech having N′ frames, where N and N′ are a positive integers, where an i is selected from the range from 1 to N for representing the i^{th} stage speech feature, and a n′ is selected from the range from 1 to N′ for representing the n′^{th} frame, comprising steps of:
(a) providing an specific n in the range from 1 to N.
(b) inputting said speech for an input time (Tᵢₙₚᵤₜ), wherein an computation from the first stage speech feature to the n^{th} stage speech feature of each frame of the speech is performed at the client end, and an computation from the (n+1)^{th} stage speech feature to the N^{th} stage speech feature of each frame of the speech is performed at the server end; and
(c) after the step (b) is carried out, an computation of the n′ frames is achieved, and a speech feature computation of the n₁^{th} stage of the (n′+1)^{th} frame is achieved, modifying the n by a specific manner according to the n₁ to minimize a computation time for recognizing the speech; and
(d) performing an computation from the first stage speech feature to the n^{th} stage speech feature of the respective remaining frames at the client end according to the modified n in step (c), while performing an computation from the (n+1)^{th} stage speech feature to the N^{th} stage speech feature of the respective remaining frames at the server end.

22. The method according to claim 21, wherein the method is used in a recording frame-synchronized speech feature computation system.

23. The method according to claim 21, wherein in the step (b) the recording frame-synchronized speech feature computation system synchronously performs the speech feature computations

24. The method according to claim 21, wherein in the step (c) an computation of the n′ frames is achieved by the recording frame-synchronized speech feature computation system.

25. The method according to claim 21, wherein the n in the step (a) is obtained by optimizing a load of a speech/user recognition system, wherein said speech/user recognition system comprises a server end, a client end and a network, and the method is achieved by performing N stages of computations for a speech feature of a speech, where N is a positive integer, and an i is selected from 1 to N for representing the i^{th} stage speech feature, comprising steps of:
(i) providing a computation time for computing a respective stage i of the speech feature at the client end, wherein a factor Ta(i) is for a computation time of computing the i^{th} stage speech feature at the client end with respect to the input time;
(ii) providing a computation time for computing a respective stage i of the speech feature at the server end, wherein a factor Tb(i) is for a computation time of computing the i^{th} stage speech feature at the server end with respect to the input time;
(iii) providing a load c of the server end and a load d of the network:
(iv) deciding an n in the range from 1 to N for minimizing a recognition time Tₒᵤₚᵤₜ of the speech:
(v) inputting the speech for being recognized with a time Tᵢₙₚᵤₜ:
(vi) performing an computation from the first stage speech feature to the n^{th} stage speech of the speech at the client end, while performing an computation from the (n+1)^{th} stage speech feature to the N^{th} stage speech feature of the speech at the server end; and
(vii) repeating steps (v) to (vi).

26. The method according to claim 21, wherein a factor Ta(i) is for a computation time of computing the i^{th} stage speech feature at the client end with respect to the input speech.

27. The method according to claim 26, wherein a factor Tb(i) is for a computation time of computing the i^{th} stage speech feature at the server end with respect to the input speech.

28. The method according to claim 27 wherein a computation time for an computation from the first stage speech feature to the n^{th} stage speech feature of said speech at the client end is
$${T}_{input} \times {\sum }_{i = 1}^{n} Ta ( i ) .$$

29. The method according to claim 28, wherein a computation time for an computation from the (n+1)^{th} stage speech feature to the N^{th} stage speech feature of said speech at the server end is
$${T}_{input} \times \frac{1}{c} {\sum }_{i = n + 1}^{N} Tb ( i ) .$$

30. The method according to claim 29, wherein a computation time for computing total N stages of the speech feature of the speech is
$${T}_{input} \times ( {\sum }_{i = 1}^{n} Ta ( i ) + \frac{1}{c} {\sum }_{i = n + 1}^{N} Tb ( i ) ) .$$

31. The method according to claim 30, wherein the data size of speech feature of stage n is Dn(Tᵢₙₚᵤₜ).

32. The method according to claim 31, wherein a time for the speech feature of stage n being transferred via the network is Dn(Tᵢₙₚᵤₜ)/d.

33. The method according to claim 32, wherein a transmitting time for a recognition result being returned by the network is K/d.

34. The method according to claim 33, wherein the specific manner in the step (c) uses:
(c1) if n₁ is smaller than n, an equation
$$n = {Arg}_{n} \text{(} Min \text{(} {T}_{input} \times \text{[} ( {\sum }_{i = 1}^{n} Ta ( i ) + \frac{1}{c} {\sum }_{i = n + 1}^{N} Tb ( i ) ) + {\sum }_{i = {n}_{1}}^{N} Ta ( i ) + \frac{1}{c} {\sum }_{i = n + 1}^{N} Tb ( i ) \text{]} + \frac{1}{d} Dn ( {T}_{input} ) + \frac{1}{d} K \text{)} \text{)} is$$
used for obtaining the modified n; and
(c2) if nᵢ is greater than n, an equation
$$n = {Arg}_{n} \text{(} Min \text{(} {T}_{input} \times \text{[} ( {\sum }_{i = 1}^{n} Ta ( i ) + \frac{1}{c} {\sum }_{i = n + 1}^{N} Tb ( i ) ) + \frac{1}{c} {\sum }_{i = {n}_{1} + 1}^{N} Tb ( i ) \text{]} + \frac{1}{d} Dn ( {T}_{input} ) + \frac{1}{d} K \text{)} \text{)}$$
is used for obtaining the modified n, wherein c is a load of the server end and d is a load of the network.

35. The method according to claim 33, wherein the c the d are obtained according to the method as recited in claim 1.

36. A method for optimizing a load of a speech/user recognition system comprising a server end, a client end and a network, wherein a recognition is achieved by performing plural stages of computations to speech features of a speech having an inputting time, comprising steps of:
(a) providing a real time factor Ta(i) for computing a respective stage i speech feature at the client end;
(b) providing a real time factor Tb(i) for computing a respective stage i speech feature at the server end;
(c) providing a load of the server end and a load of the network;
(d) obtaining a specific amount according to the load of the server end and the load of the network to minimize a computation time for recognizing said speech; and
(e) determining the computations at the client end and the server end according to the specific amount and the performing the plural stages of computations for the speech features of the speech.

37. The method according to claim 36, wherein the step (c) further comprises steps of:
(c1) inputting a first speech to be recognized during a first input time, where an accomplishment of a recognition of the first speech is a first output time; and
(c2) inputting a second speech to be recognized during a second input time, where an accomplishment of a recognition of the second speech is a second output time; and
(c3) estimating the load of the server end and the load of the network according to the first and second output times of (c1) and (c2).

38. The method according to claim 36, wherein the computation time for computing all stages of the speech feature at the client end is directly proportional to the inputting time.

39. The method according to claim 36, wherein the computation time for computing all stages of the speech feature at the server end is directly proportional to the inputting time.

40. The method according to claim 36, wherein the speech includes a data size.

41. The method according to claim 36, wherein a time for transferring the speech feature via network is a ratio of the data size to the load of the network.

42. The method according to claim 36, wherein a time for computing the stages of the speech feature is a summation of the respective times for computing the speech feature at the client end and at the server end.

43. The method according to claim 36, wherein an output time of the speech is a summation of the computation time for computing said all stages of said speech feature, the time for transmitting the speech feature via the network, and the time for transmitting a recognition result via the network.

44. A method for optimizing a recording frame-synchronized speech feature computation comprising a server end, a client end and a network, wherein a recognition of a speech is achieved by performing plural stages of computations for speech features of the speech having plural frames, comprising steps of:
(a) providing a specific amount;
(b) inputting the speech for an input time;
(c) after the step (b) is carried out when a part of the plural frames has not been computed, and only part computations of the plural stages for the speech feature of a first frame of the frames having not been computed, modifying the specific amount by specific manner, to minimize a computation time for recognizing the speech; and
(d) distributing the respective loads of the server end and the client end according to the modified specific amount in the step (c) and then performing computations for the frames having not been computed to achieve the recognition.

45. The method according to claim 44, wherein the method is used in a recording frame-synchronized speech feature computation system.

46. The method according to claim 44, wherein the recording frame-synchronized speech feature computation system synchronously performs the speech feature computations, wherein the system distributes the respective computation at the client end and the server end according to the specific amount.

47. The method according to claim 44, wherein the specific amount in the step a is obtained by optimizing a load of a speech/user recognition system, wherein said speech/user recognition system comprises a server end, a client end and a network, and the method is achieved by performing N stages of computations for a speech feature of a speech, where N is a positive integer, and an i is selected from 1 to N for representing the i^{th} stage speech feature, comprising steps of:
(i) providing a computation time for computing a respective stage i of the speech feature at the client end, wherein a factor Ta(i) is for a computation time of computing the i^{th} stage speech feature at the client end with respect to the input time;
(ii) providing a computation time for computing a respective stage i of the speech feature at the server end, wherein a factor Tb(i) is for a computation time of computing the i^{th} stage speech feature at the server end with respect to the input time;
(iii) providing a load c of the server end and a load d of the network;
(iv) deciding an n in the range from 1 to N for minimizing a recognition time Tₒᵤₚᵤₜ of the speech;
(v) inputting the speech for being recognized with a time Tᵢₙₚᵤₜ;
(vi) performing an computation from the first stage speech feature to the n^{th} stage speech of the speech at the client end, while performing an computation from the (n+1)^{th} stage speech feature to the N^{th} stage speech feature of the speech at the server end; and
(vii) repeating steps (v) to (vi).

48. The method according to claim 44, wherein a computation time for computing one of the plural stages of computations at the client end is directly proportional to the input time.

49. The method according to claim 44, wherein a computation time for computing one of the plural stages of computations at the server end is directly proportional to the input time.

50. The method according to claim 44, wherein the speech includes a data size.

51. The method according to claim 44, wherein a time for transmitting the speech feature via the network is the ratio of the data size to the load of the network.

52. The method according to claim 44, wherein a time for all plural stages of computations is the summation of a time for computing the speech feature at the client end and a time for computing the speech feature at the server end.

53. The method according to claim 44, wherein an output time of the speech is a summation of a time for computing the speech feature, a time for transmitting the speech feature via the network, and a time for transmitting a recognition result via the network.
